(19) United States
(12) Patent Application Publication
(10) Pub. No.: US 2022/0327283 A1
(43) Pub. Date: Oct. 13, 2022

(54) MOBILE TERMINAL SUPPORTING ELECTRONIC NOTE FUNCTION, AND METHOD FOR CONTROLLING SAME

(71) Applicant: SAMSUNG ELECTRONICS CO., LTD., Suwon-si (KR)

(72) Inventors: Juwan LEE, Suwon-si Gyeonggi-do (KR); Yoonjae PARK, Suwon-si Gyeonggi-do (KR); Jinwoo PARK, Suwon-si Gyeonggi-do (KR); Jooyong BYEON, Suwon-si Gyeonggi-do (KR); Jaeyung YEO, Suwon-si Gyeonggi-do (KR)

(21) Appl. No.: 17/852,846

(22) Filed: Jun. 29, 2022

Related U.S. Application Data
(63) Continuation of application No. PCT/KR2020/018875, filed on Dec. 22, 2020.

(30) Foreign Application Priority Data
Dec. 31, 2019 (KR) 10-2019-0179207

(51) Int. Cl. G06F 40/279; G06F 40/166

(52) U.S. Cl. CPC G06F 40/279; G06F 40/166

(57) ABSTRACT

An electronic device can include a memory which stores a plurality of applications including an electronic note application and at least one electronic note file, and a processor connected to the memory. The memory further stores instructions which, when executed, cause the processor to identify contents included in the electronic note file, compare the identified contents with data forms corresponding to the plurality of applications, estimate a category of the electronic note file based on a result of comparing the identified contents with the data forms of the plurality of applications, and store the identified contents in an application corresponding to the category among the plurality of applications.

### CROSS-REFERENCE TO RELATED APPLICATION(s)

This application is a continuation application, claiming priority under § 365(c), of an International Application No. PCT/KR2020/018875, filed on Dec. 22, 2020, which is based on and claims the benefit of a Korean patent application number 10-2019-0179207, filed on Dec. 31, 2019, in the Korean Intellectual Property Office, the disclosure of which is incorporated by reference herein in its entirety.

### TECHNICAL FIELD

Various embodiments of the present disclosure relate to a mobile terminal supporting an electronic note function, and a method for controlling the same, capable of allowing a user to conveniently use an electronic note function by classifying and storing input electronic notes.

### BACKGROUND ART

A personal mobile terminal such as a smart phone, for example, provides various functions such as a note, a diary, a dictionary, a digital camera, and web browsing beyond a simple call function. Among them, the electronic note function (or electronic memo function) provides a user with a function for storing, editing and searching for texts and/or drawings input to the mobile terminal using a digital pen, a touch input onto a touch keyboard and/or touch screen or the as a digital note (memo) file without paper or pen. Accordingly, a user can to quickly and conveniently create, store and recall a note.

However, the current electronic note function is managed for each note file stored in an electronic note application. Therefore, current electronic note functions require the user to separately manage a several fragmented note files. As a result, current note functions may provide a user with a low utilization and cumbersome management experience.

### DISCLOSURE

### Technical Problem

According to various embodiments disclosed herein, a mobile terminal and a method for controlling the same provide an electronic note function which is capable of more effectively classifying, storing, and managing a plurality of electronic note files based on database to a user.

### Technical Solution

According to an embodiment of the disclosure, an electronic device can include a memory which stores a plurality of applications including an electronic note application and at least one electronic note file, and a processor connected to the memory. The memory can further store instructions which, when executed, cause the processor to identify contents included in the electronic note file, compare the identified contents with data forms of the plurality of applications, estimate a category of the electronic note file based on a result of comparing the identified contents with the data forms of the plurality of applications, and store the identified contents in an application corresponding to the category among the plurality of applications.

According to an embodiment of the disclosure, a method is provided for managing an electronic note. The method comprises: identifying contents included in an electronic note file stored in a memory of an electronic device, comparing the identified contents with data forms of a plurality of applications stored in the memory, estimating a category of the electronic note file based on a result of comparing the identified contents with the data forms of the plurality of applications, and storing the identified contents in an application corresponding to the category among the plurality of applications.

### ADVANTAGEOUS EFFECTS

According to various embodiments disclosed herein, a mobile terminal and a method for controlling the same provides an electronic note function capable of increasing the utilization of the electronic note function and reducing user inconvenience by more effectively classifying, storing, and managing a plurality of electronic note files based on a database to a user.

### BRIEF DESCRIPTION OF DRAWINGS

FIG. 1 is a block diagram of an electronic device in a network environment, according to an embodiment.

FIG. 2 is a diagram illustrating a configuration of an electronic device according to an embodiment.

FIG. 3 is a flowchart illustrating an operation of an electronic device according to an embodiment.

FIG. 4 is a flowchart illustrating an operation of analyzing an electronic note in an electronic device according to an embodiment.

FIG. 5 is a diagram schematically illustrating a method for analyzing a pattern of an electronic note in an electronic device according to an embodiment.

FIG. 6 is a diagram schematically illustrating a method for analyzing a pattern of an electronic note in an electronic device according to an embodiment.

FIG. 7 is a diagram schematically illustrating a method for analyzing an intent of an electronic note in an electronic device according to an embodiment.

FIG. 8 is a diagram schematically illustrating a method for correcting contents identified from an electronic note in an electronic device, according to an embodiment.

FIG. 9 is a diagram schematically illustrating a method for analyzing and storing an electronic note in an electronic device and a method for searching for stored contents at a user's request in the electronic device, according to an embodiment.

FIG. 10 is a flowchart illustrating an operation of an electronic device according to an embodiment.

In connection with the description of the drawings, the same or similar reference numerals may be used for the same or similar components.

### BEST MODE

Hereinafter, various embodiments of the disclosure may be described with reference to accompanying drawings. Accordingly, those of ordinary skill in the art will recognize that modification, equivalent, and/or alternative on the various embodiments described herein can be variously made without departing from the scope and spirit of the disclosure.

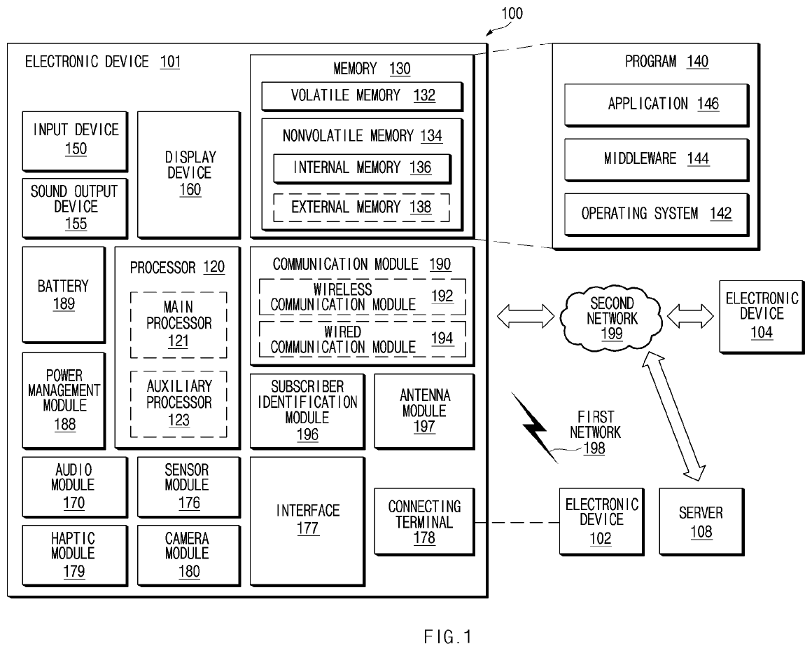

Hereinafter, a configuration of an electronic device according to an embodiment is described with reference to FIG. 1

FIG. 1 is a block diagram of an electronic device 101 in a network environment 100 according to various embodiments. Referring to FIG. 1, the electronic device 101 may communicate with an electronic device 102 through a first network 198 (e.g., a short-range wireless communication network) or may communicate with an electronic device 104 or a server 108 through a second network 199 (e.g., a long-distance wireless communication network) in a network environment 100. According to an embodiment, the electronic device 101 may communicate with the electronic device 104 through the server 108. According to an embodiment, the electronic device 101 may include a processor 120, a memory 130, an input device 150, a sound output device 155, a display device 160, an audio module 170, a sensor module 176, an interface 177, a haptic module 179, a camera module 180, a power management module 188, a battery 189, a communication module 190, a subscriber identification module 196, or an antenna module 197. According to some embodiments, at least one (e.g., the display device 160 or the camera module 180) among components of the electronic device 101 may be omitted or one or more other components may be added to the electronic device 101. According to some embodiments, some of the above components may be implemented with one integrated circuit. For example, the sensor module 176 (e.g., a fingerprint sensor, an iris sensor, or an illuminance sensor) may be embedded in the display device 160 (e.g., a display).

The processor 120 may execute, for example, software (e.g., a program 140) to control at least one of other components (e.g., a hardware or software component) of the electronic device 101 connected to the processor 120 and may process or compute a variety of data. According to an embodiment, as a part of data processing or operation, the processor 120 may load a command set or data, which is received from other components (e.g., the sensor module 176 or the communication module 190), into a volatile memory 132, may process the command or data loaded into the volatile memory 132, and may store result data into a nonvolatile memory 134. According to an embodiment, the processor 120 may include a main processor 121 (e.g., a central processing unit or an application processor) and an auxiliary processor 123 (e.g., a graphic processing device, an image signal processor, a sensor hub processor, or a communication processor), which operates independently from the main processor 121 or with the main processor 121. Additionally or alternatively, the auxiliary processor 123 may use less power than the main processor 121, or is specified to a designated function. The auxiliary processor 123 may be implemented separately from the main processor 121 or as a part thereof.

The auxiliary processor 123 may control, for example, at least some of functions or states associated with at least one component (e.g., the display device 160, the sensor module 176, or the communication module 190) among the components of the electronic device 101 instead of the main processor 121 while the main processor 121 is in an inactive (e.g., sleep) state or together with the main processor 121 while the main processor 121 is in an active (e.g., an application execution) state. According to an embodiment, the auxiliary processor 123 (e.g., the image signal processor or the communication processor) may be implemented as a part of another component (e.g., the camera module 180 or the communication module 190) that is functionally related to the auxiliary processor 123.

The memory 130 may store a variety of data used by at least one component (e.g., the processor 120 or the sensor module 176) of the electronic device 101. For example, data may include software (e.g., the program 140) and input data or output data with respect to commands associated with the software. The memory 130 may include the volatile memory 132 or the nonvolatile memory 134.

The program 140 may be stored in the memory 130 as software and may include, for example, an operating system 142, a middleware 144, or an application 146.

The input device 150 may receive a command or data, which is used for a component (e.g., the processor 120) of the electronic device 101, from an outside (e.g., a user) of the electronic device 101. The input device 150 may include, for example, a microphone, a mouse, a keyboard, or a digital pen (e.g., a stylus pen).

The sound output device 155 may output a sound signal to the outside of the electronic device 101. The sound output device 155 may include, for example, a speaker or a receiver. The speaker may be used for general purposes, such as multimedia play or recordings play, and the receiver may be used for receiving calls. According to an embodiment, the receiver and the speaker may be either integrally or separately implemented.

The display device 160 may visually provide information to the outside (e.g., the user) of the electronic device 101. For example, the display device 160 may include a display, a hologram device, or a projector and a control circuit for controlling a corresponding device. According to an embodiment, the display device 160 may include a touch circuitry configured to sense the touch or a sensor circuit (e.g., a pressure sensor) for measuring an intensity of pressure on the touch.

The audio module 170 may convert a sound and an electrical signal in dual directions. According to an embodiment, the audio module 170 may obtain the sound through the input device 150 or may output the sound through the sound output device 155 or an external electronic device (e.g., the electronic device 102 (e.g., a speaker or a headphone)) directly or wirelessly connected to the electronic device 101.

The sensor module 176 may generate an electrical signal or a data value corresponding to an operating state (e.g., power or temperature) inside or an environmental state (e.g., a user state) outside the electronic device 101. According to an embodiment, the sensor module 176 may include, for example, a gesture sensor, a gyro sensor, a barometric pressure sensor, a magnetic sensor, an acceleration sensor, a grip sensor, a proximity sensor, a color sensor, an infrared sensor, a biometric sensor, a temperature sensor, a humidity sensor, or an illuminance sensor.

The interface 177 may support one or more designated protocols to allow the electronic device 101 to connect directly or wirelessly to the external electronic device (e.g., the electronic device 102). According to an embodiment, the interface 177 may include, for example, an HDMI (high-definition multimedia interface), a USB (universal serial bus) interface, an SD card interface, or an audio interface.

A connecting terminal 178 may include a connector that physically connects the electronic device 101 to the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal to a mechanical stimulation (e.g., vibration or movement) or an electrical stimulation perceived by the user through tactile or kinesthetic sensations. According to an embodiment, the haptic module 179 may include, for example, a motor, a piezoelectric element, or an electric stimulator.

The camera module 180 may shoot a still image or a video image. According to an embodiment, the camera module 180 may include, for example, at least one or more lenses, image sensors, image signal processors, or flashes.

The power management module 188 may manage power supplied to the electronic device 101. According to an embodiment, the power management module 188 may be implemented as at least a part of a power management integrated circuit (PMIC).

The battery 189 may supply power to at least one component of the electronic device 101. According to an embodiment, the battery 189 may include, for example, a non-rechargeable (primary) battery, a rechargeable (secondary) battery, or a fuel cell.

The communication module 190 may establish a direct (e.g., wired) or wireless communication channel between the electronic device 101 and the external electronic device (e.g., the electronic device 102, the electronic device 104, or the server 108) and support communication execution through the established communication channel. The communication module 190 may include at least one communication processor operating independently from the processor 120 (e.g., the application processor) and supporting the direct (e.g., wired) communication or the wireless communication. According to an embodiment, the communication module 190 may include a wireless communication module 192 (e.g., a cellular communication module, a short-range wireless communication module, or a GNSS (global navigation satellite system) communication module) or a wired communication module 194 (e.g., an LAN (local area network) communication module or a power line communication module). The corresponding communication module among the above communication modules may communicate with the external electronic device 104 through the first network 198 (e.g., the short-range communication network such as a Bluetooth, a WiFi direct, or an IrDA (infrared data association)) or the second network 199 (e.g., the long-distance wireless communication network such as a cellular network, an internet, or a computer network (e.g., LAN or WAN)). The above-mentioned various communication modules may be implemented into one component (e.g., a single chip) or into separate components (e.g., chips), respectively. The wireless communication module 192 may identify and authenticate the electronic device 101 using user information (e.g., international mobile subscriber identity (IMSI)) stored in the subscriber identification module 196 in the communication network, such as the first network 198 or the second network 199.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some components among the components may be connected to each other through a communication method (e.g., a bus, a GPIO (general purpose input and output), an SPI (serial peripheral interface), or an MIPI (mobile industry processor interface)) used between peripheral devices to exchange signals (e.g., a command or data) with each other.

According to an embodiment, the command or data may be transmitted or received between the electronic device 101 and the external electronic device 104 through the server 108 connected to the second network 199. Each of the external electronic devices 102 and 104 may be the same or different types as or from the electronic device 101. According to an embodiment, all or some of the operations performed by the electronic device 101 may be performed by one or more external electronic devices among the external electronic devices 102, 104, or 108. For example, when the electronic device 101 performs some functions or services automatically or by request from a user or another device, the electronic device 101 may request one or more external electronic devices to perform at least some of the functions related to the functions or services, in addition to or instead of performing the functions or services by itself. The one or more external electronic devices receiving the request may carry out at least a part of the requested function or service or the additional function or service associated with the request and transmit the execution result to the electronic device 101. The electronic device 101 may provide the result as is or after additional processing as at least a part of the response to the request. To this end, for example, a cloud computing, distributed computing, or client-server computing technology may be used.

The electronic device according to various embodiments disclosed in the disclosure may be various types of devices. The electronic device may include, for example, a portable communication device (e.g., a smartphone), a computer device, a portable multimedia device, a mobile medical appliance, a camera, a wearable device, or a home appliance. The electronic device according to an embodiment of the disclosure should not be limited to the above-mentioned devices.

It should be understood that various embodiments of the disclosure and terms used in the embodiments do not intend to limit technical features disclosed in the disclosure to the particular embodiment disclosed herein; rather, the disclosure should be construed to cover various modifications, equivalents, or alternatives of embodiments of the disclosure. With regard to description of drawings, similar or related components may be assigned with similar reference numerals. As used herein, singular forms of noun corresponding to an item may include one or more items unless the context clearly indicates otherwise. In the disclosure disclosed herein, each of the expressions “A or B”, “at least one of A and B”, “at least one of A or B”, “A, B, or C”, “one or more of A, B, and C”, or “one or more of A, B, or C”, and the like used herein may include any and all combinations of one or more of the associated listed items. The expressions, such as “a first”, “a second”, “the first”, or “the second”, may be used merely for the purpose of distinguishing a component from the other components, but do not limit the corresponding components in other aspect (e.g., the importance or the order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

The term “module” used in the disclosure may include a unit implemented in hardware, software, or firmware and may be interchangeably used with the terms “logic”, “logical block”, “part” and “circuit”. The “module” may be a minimum unit of an integrated part or may be a part thereof. The “module” may be a minimum unit for performing one or more functions or a part thereof. For example, according to an embodiment, the “module” may include an application-specific integrated circuit (ASIC).

Various embodiments of the disclosure may be implemented by software (e.g., the program 140) including an instruction stored in a machine-readable storage medium (e.g., an internal memory 136 or an external memory 138) readable by a machine (e.g., the electronic device 101). For example, the processor (e.g., the processor 120) of a machine (e.g., the electronic device 101) may call the instruction from the machine-readable storage medium and execute the instructions thus called. This means that the machine may perform at least one function based on the called at least one instruction. The one or more instructions may include a code generated by a compiler or executable by an interpreter. The machine-readable storage medium may be provided in the form of non-transitory storage medium. Here, the term “non-transitory”, as used herein, means that the storage medium is tangible, but does not include a signal (e.g., an electromagnetic wave). The term “non-transitory” does not differentiate a case where the data is permanently stored in the storage medium from a case where the data is temporally stored in the storage medium.

According to an embodiment, the method according to various embodiments disclosed in the disclosure may be provided as a part of a computer program product. The computer program product may be traded between a seller and a buyer as a product. The computer program product may be distributed in the form of machine-readable storage medium (e.g., a compact disc read only memory (CD-ROM)) or may be directly distributed (e.g., download or upload) online through an application store (e.g., a Play Store™) or between two user devices (e.g., the smartphones). In the case of online distribution, at least a portion of the computer program product may be temporarily stored or generated in a machine-readable storage medium such as a memory of a manufacturer's server, an application store's server, or a relay server.

According to various embodiments, each component (e.g., the module or the program) of the above-described components may include one or plural entities. According to various embodiments, at least one or more components of the above components or operations may be omitted, or one or more components or operations may be added. Alternatively or additionally, some components (e.g., the module or the program) may be integrated in one component. In this case, the integrated component may perform the same or similar functions performed by each corresponding components prior to the integration. According to various embodiments, operations performed by a module, a programming, or other components may be executed sequentially, in parallel, repeatedly, or in a heuristic method, or at least some operations may be executed in different sequences, omitted, or other operations may be added.

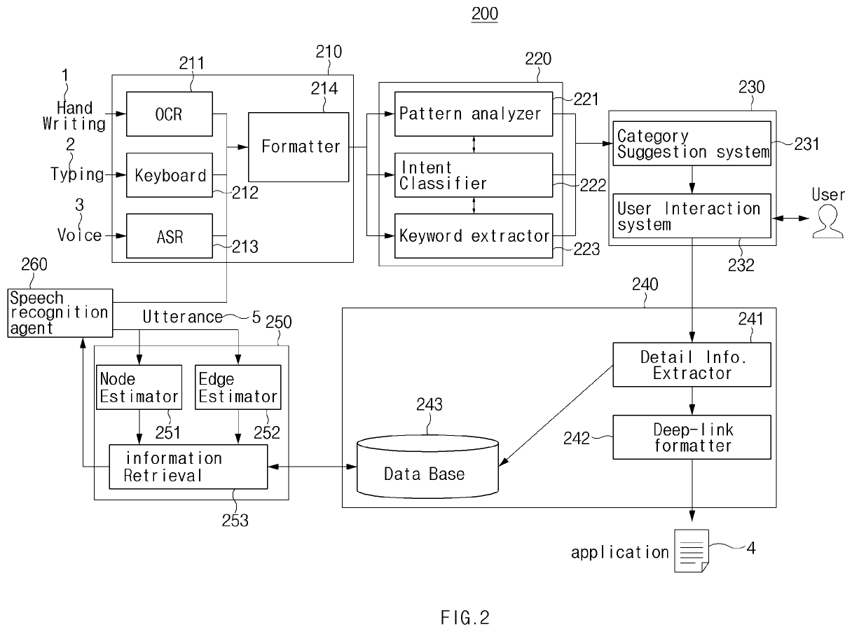

Hereinafter, a configuration of an electronic device according to an embodiment will be described with reference to FIG. 2. FIG. 2 is a block diagram 200 illustrating a configuration of an electronic device 200 according to an embodiment. The electronic device (e.g., the electronic device 101 of FIG. 1) can include an input processing module 210, an input analysis module 220, a category suggestion module 230, a database module 240, and an information retrieval module 250. According to an embodiment, the control and operation of the input processing module 210, the input analysis module 220, the category suggestion module 230, the database module 240, and the information retrieval module 250 can be performed by a processor of the electronic device (e.g., the processor 120 of FIG. 1).

According to an embodiment, the input processing module 210 may include an optical character recognition (OCR) 211, a keyboard 212, an automatic speech recognition (ASR) 213, and a formatter 214, and can receive and process a user's input.

According to an embodiment, the input processing module 210 can receive a user's hand writing 1, typing 2, voice 3 or the like using a digital pen or the like through an electronic note application.

According to an embodiment, the electronic note application can be stored in a memory (e.g., the memory 130 of FIG. 1) and executed by the processor (e.g., the processor 120 of FIG. 1). For example, a user can execute an electronic note function in the electronic device (e.g., the electronic device 101 of FIG. 1) by selecting an application in which a note function is implemented among applications (e.g., the applications 246 of FIG. 1) stored in the memory (e.g., the memory 130 of FIG. 1) of the electronic device (e.g., the electronic device 101 of FIG. 1).

According to an embodiment, various types of data for executing the electronic note function can be stored in the memory of the electronic device. For example, data being (e.g., text, image, voice, or video) recorded in a note by the user while the electronic note function is being executed can be stored in the memory. At least one note data and a sheet of data included in each of notes can be stored in the memory.

According to an embodiment, a display device (e.g., the display device 160 of FIG. 1) can display an execution screen, on which the electronic note application is executed, in real time, and can also receive a user input from the user through an input device (e.g., the input device 150 in FIG. 1) while the note function is being executed.

According to an embodiment, the input processing module 210 can convert the received user's hand writing 1 into text data which the processor is able to process through the optical character recognition (OCR) 211. According to an embodiment, the input processing module 210 can receive the user's typing 2 through the keyboard 212. According to an embodiment, the input processing module 210 can convert the received user's voice 3 into text data which the processor is able to process through the ASR 213.

According to an embodiment, input data received by the OCR 211, the keyboard 212, and/or the ASR 213 can be delivered to the formatter 214, and the input processing module 210 can generate text data in which errors or unclear portions of input data are corrected through the formatter 214.

According to an embodiment, the input analysis module 220 can include a pattern analyzer 221, an intent classifier 222, and a keyword extractor 223.

According to an embodiment, input data input by the user can be received by the input processing module and delivered to the input analysis module 220. Accordingly, the input data delivered to the input analysis module 220 can be refined data which has been processed and/or corrected through the input processing module 210.

According to an embodiment, the input analysis module 220 can extract information from the input data received from the input processing module 210 and analyze contents intended by the user. According to an embodiment, the input analysis module 220 can transmit the input data received from the input processing module 210 to the pattern analyzer 221 to analyze the pattern of the data. According to an embodiment, the pattern analyzer 221 can identify at least one data form which correspond to applications stored in the electronic device. The applications include, but are not limited to, a calendar application, a music playback application, a vocabulary application, a to-do list application, and a household account book. For example, the data form corresponding to a calendar application can include date and time, and can further include a place and/or to-do list according to an embodiment. For example, the data form corresponding to a music playback application can include a song title and a singer, and can further include a genre or the like according to an embodiment. For example, the data form corresponding to a vocabulary application can include foreign language words and native language words. For example, the data form corresponding to a to-do list application can include only to-do information without time information. For example, the data form corresponding to a household account book application can include a place of purchase or a list of purchases and a purchase amount.

According to an embodiment, the pattern analyzer 221 can analyze a pattern of input data received from the input processing module 210 to determine which application data format corresponds to the pattern. For example, when the contents corresponding to a place of purchase such as named “a market” and contents corresponding to a purchase price “8,000 won” are included as a result of analyzing the pattern of the data in the pattern analyzer 221, the pattern analyzer 221 can make an analysis as a purchase of “8,000 won” at the named “a market” by determining the contents of the electronic note as the data form of the household account book application.

For example, when first contents (e.g., a foreign language word) for a specific word (e.g., harness) and second contents (e.g., a native language word) for the specific word are included as a result of analyzing the pattern of the data in the pattern analyzer 221, the pattern analyzer 221 can determine the contents of the electronic note as the data form of the vocabulary application. According to an embodiment, the determination of the native language can be performed based on the user's settings of the electronic device.

For example, when contents corresponding to a song title and contents corresponding to a singer's name on the right side of the song title are included as a result of analyzing the pattern of the data in the pattern analyzer 221, the pattern analyzer 221 can determine the contents of the electronic note as the data form for a play list of a music playback application.

For example, when contents corresponding to information about a to-do thing without time information, such as “shopping” are included as a result of analyzing the pattern of the data in the pattern analyzer 221, the pattern analyzer 221 can determine the contents of the electronic note as the data form of a to-do list application.

According to an embodiment, the input analysis module 220 can transmit the input data received from the input processing module 210 to an intent classifier 222, which analyzes a visual part of note data. Accordingly, the intent classifier 222 can determine the intent of the note to comprehensively analyze the intent of the note data. According to an embodiment, the intent classifier 222 can analyze the visual part of the note data to determine various visual characteristics or attributes of the note data. The visual characteristics or attributes include, but are not limited to, a distance between pieces of contents of the note data, an arrangement of pieces of contents, an order of pieces of contents, and the like. For example, when “patent meeting” and “2 o′clock” are input on the same line, and “concall” and “4 o′clock” are input on the same line as a result of analyzing the note data in the intent classifier 222, the intent classifier 222 can determine that the contents of the note are to mean that “patent meeting” is at “2 o′clock” and “concall” (e.g., a conference call) is at “4 o′ clock”.

According to an embodiment, the input analysis module 220 can transmit input data received from the input processing module 210 to the keyword extractor 223 to extract the keyword of the note data. For example, when a clear intent of the user such as “to do: shopping” is input as a result of extracting a keyword from the note contents in the keyword extractor 223, the keyword extractor 223 can extract the keyword and determine that the note contents are intended to create a to-do list.

According to an embodiment, the category suggestion module 230 can receive analyzed data from the input analysis module 220, and can include a category suggestion system 231 and a user interaction system 232.

According to an embodiment, the category suggestion system 231 can determine an appropriate category for the data received from the input analysis module 220. For example, the category can be a type of application (e.g., a calendar, a to-do list, a vocabulary list, or the like), and the appropriate category can refer to a category having a relevance with note data, which is greater than or equal to a specific reference threshold. According to an embodiment, the category suggestion system 231 can store a history of the result of determining the category of at least one note data, and determine an appropriate category for the data received from the input analysis module 220 based on the history. According to an embodiment, the category suggestion system 231 can suggest a plurality of categories determined to be appropriate for the data received from the input analysis module 220.

According to an embodiment, the user interaction system 232 can receive the user's feedback by providing the user with at least one category determined by the category suggestion system 231. The category suggestion module 230 can finally determine the category of the note data based on the feedback received from the user in the user interaction system 232.

According to an embodiment, the database module 240 can receive data from the category suggestion module 230, extract specific information, form the specific information into structural data, and store the structural data in the database. According to an embodiment, the database module 240 can include a detail information extractor (also referred to herein as a “detail info. extractor”) 241, a deep link formatter 242, and database 243.

According to an embodiment, the detail information extractor 241 can structure a sentence by semantically parsing a sentence in the data received from the category suggestion module 230. For example, by semantically parsing the sentence “tomorrow laundry”, the sentence can be structured into “tomorrow”->“to do”->“laundry”.

According to an embodiment, information structured in the detail information extractor 241 can be transmitted to the database 243 and stored in the database 243 in the form of a table, a knowledge based graph, or the like. Information stored in the database 243 can be inquired and modified through a voice recognition agent 260 included in the electronic device.

According to an embodiment, the deep link formatter 242 can form data which has passed through the detail information extractor 241 in the form of a deep link and transmit the data to the current application or another application to store the data together with the corresponding note data.

According to an embodiment, the information retrieval module 250 can collect and provide information stored in the database 243 at a request, and can include a node estimator 251, an edge estimator 252, and an information retrieval 253. For example, when a sentence for searching the note contents is input through the voice recognition agent 260, the information retrieval module 250 can allow the sentence to pass through the node estimator 251 which estimates a node which the sentence is intending to find and the edge estimator 252 which estimates an edge of the corresponding node which is to be found. For example, when an utterance 5 such as “what is it to do today?” or “what is there to do today?”, is input through the voice recognition agent 260, the node estimator 251 can analyze, as “to do”, a node, which is an element to be found in the utterance and, as “today”, an edge which is detail information that the edge estimator 252 wants to find in the corresponding utterance.

According to an embodiment, the information retrieval 253 can collect information by searching the database 243 based on the node and edge information estimated through the node estimator 251 and the edge estimator 252 and deliver the result thereof to the voice recognition agent 260. For example, when appropriate information with a relevance with the estimated node or edge, which is greater than or equal to a predetermined value, is collected, the information retrieval 253 can deliver the result thereof to the voice recognition agent 260. The voice recognition agent 260 can provide information received from the information retrieval 253 to the user in response to the user's utterance 5.

The components of the electronic device described with reference to FIG. 2 are exemplary, and some of the components of FIG. 2 may be omitted or some components and processes may be merged and performed in one component or as one operation.

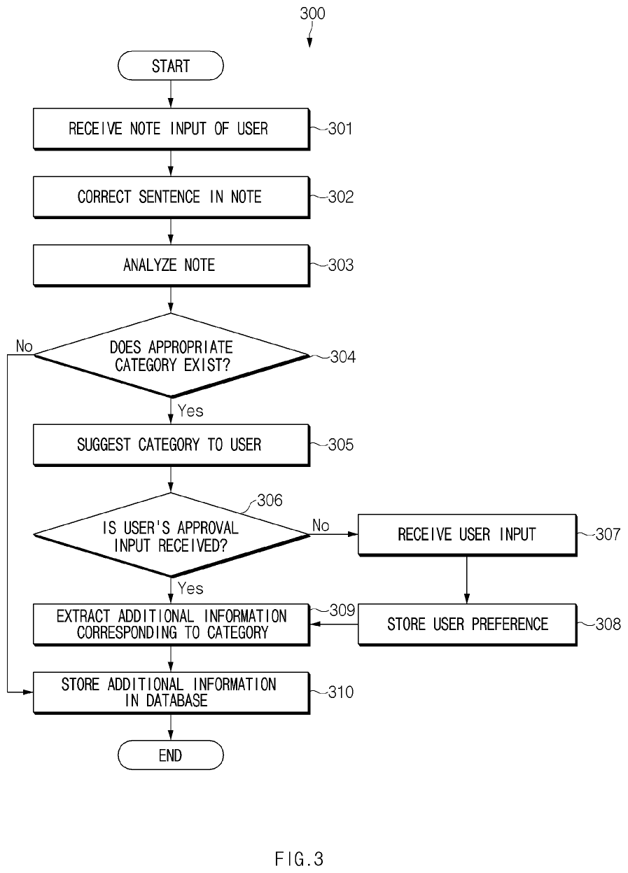

Hereinafter, operation of an electronic device according to an embodiment will be described with reference to FIG. 3. FIG. 3 is a flowchart 300 illustrating operation of an electronic device according to an embodiment. At operation 301, an electronic device (e.g., the electronic device 101 of FIG. 1) according to an embodiment can receive a user's note input using an electronic note application. The user's note input can include handwriting, or drawing using a digital pen or touch input, typing through a keyboard, voice input, and the like.

At operation 302, the electronic device according to an embodiment can correct portions of input data or content in the note. For example, when there is a word with unclear meaning in a phrase or a sentence as a result of processing the user's note input through OCR, ASR, or the like, such as a typo “buy umbrell”, the phrase or sentence in the note can be corrected to “buy umbrella” by making a correction to “umbrella” with a clear meaning. When it is determined that there is no part to be corrected in the phrases or sentences in the note, the electronic device can omit operation 302.

At operation 303, the electronic device according to an embodiment can analyze the note. According to an embodiment, the electronic device can analyze the contents of the note, the relationship between pieces of contents, the distance between pieces of contents, the arrangement of pieces of contents, the order of pieces of contents, or the like using at least one of a pattern analyzer, an intent classifier, and a keyword extractor. According to an embodiment, the electronic device can identify a data form of an application included in the electronic device, and analyze the contents of note by comparing data included in the note with the data form of the application.

At operation 304, the electronic device according to an embodiment can determine whether an appropriate category exists based on the analyzed contents of the note. According to an embodiment, the category can correspond to a type of an application (e.g., a calendar, a vocabulary list, a music playback application, or the like), and the appropriate category can refer to a category having a relevance with the contents of the note which is greater than or equal to a predetermined value. According to an embodiment, when it is determined at operation 304 that an appropriate category does not exist for the note, at operation 310 the electronic device can store the note in database (e.g., the database 243 of FIG. 2) as a general note without classification.

At operation 305, when an appropriate category for the note exists, the electronic device according to an embodiment can suggest the category to a user. According to an embodiment, the electronic device can suggest one or more recommendation categories to the user.

At operation 306, the electronic device according to an embodiment can determine whether there is the user's approval input for one or more recommendation categories suggested to the user. When a rejection input for a recommendation category is received or no input is received from the user at operation 306, the electronic device can receive the user's direct input for the category at operation 307. At operation 307, the electronic device can receive an input of a corresponding category for a corresponding note from the user by displaying a touch keyboard or the like, and/or receive a user's selection input for the at least one re-recommendation category by re-suggesting at least one recommendation category.

At operation 308, the electronic device according to an embodiment can store, as the user's preference, a category received from the user in the database in association with corresponding note contents.

At operation 309, after the category of the note is determined, the electronic device can extract additional detail information corresponding to a category from the note. For example, when the category of the note is determined as “calendar”, the electronic device can extract detail information of at least one of “date”, “time”, “place”, “to do”, and the like corresponding to the data form of “calendar”, from the note. For example, by extracting detail information from a sentence “Return book to library by Thursday”, the sentence can be structured as “Thursday”->“Library”->“Return books”.

At operation 310, the electronic device according to an embodiment can store data obtained by analyzing notes in the database (e.g., the database 243 of FIG. 2). For example, the electronic device can store category information, structuring information, and the like obtained by analyzing notes in the database. Further, the electronic device can store category information, structuring information, and the like obtained by analyzing notes as note data.

The flowchart of FIG. 3 is merely an example, and some of the flowchart of FIG. 3 may be omitted or the order of the flowchart may be changed. Also, some of the flowchart of FIG. 3 may be merged and performed as one process, or may be separated and performed as a plurality of processes.

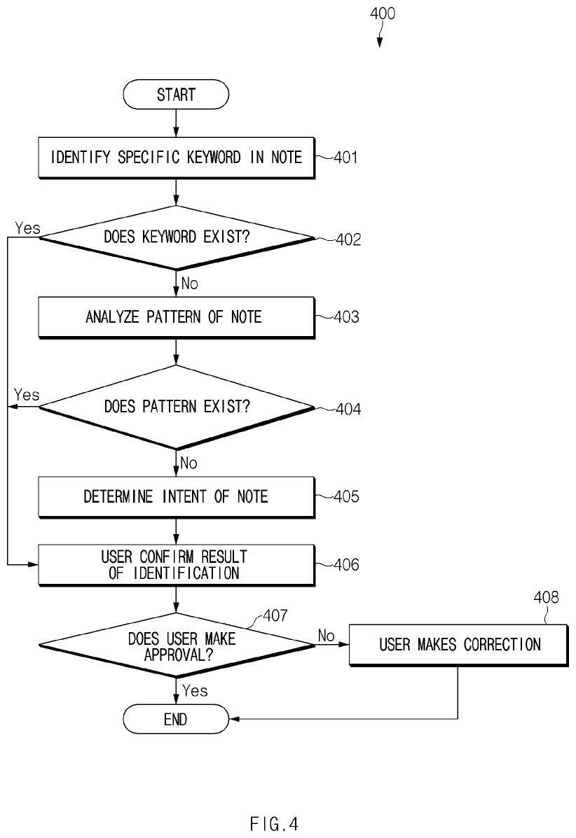

Hereinafter, an operation of analyzing an electronic note of an electronic device according to an embodiment will be described with reference to FIGS. 4 to 8. FIG. 4 is a flowchart 400 illustrating an operation of analyzing an electronic note of an electronic device according to an embodiment. FIG. 4 can be a diagram illustrating in detail operation 303 of FIG. 3. At operation 401, according to an embodiment, an electronic device (e.g., the electronic device 101 of FIG. 1) can identify a specific keyword in an electronic note. According to an embodiment, the specific keyword can refer to a word clearly indicating a user's intent, such as “to do”.

According to an embodiment, when the electronic device determines that a keyword exists in the electronic note at operation 402, the electronic device can receive a user's feedback as to determine whether the keyword recognized at operation 406 matches the user's intent.

According to an embodiment, when the electronic device determines that the keyword does not exist in the electronic note at operation 402, the electronic device can analyze the pattern of the electronic note at operation 403. When it is determined at operation 404 that the pattern exists in the electronic note, the electronic device can receive the user's feedback for a result of analyzing the pattern at operation 406. The user's feedback can include, for example, an input confirming the result of analyzing the pattern.

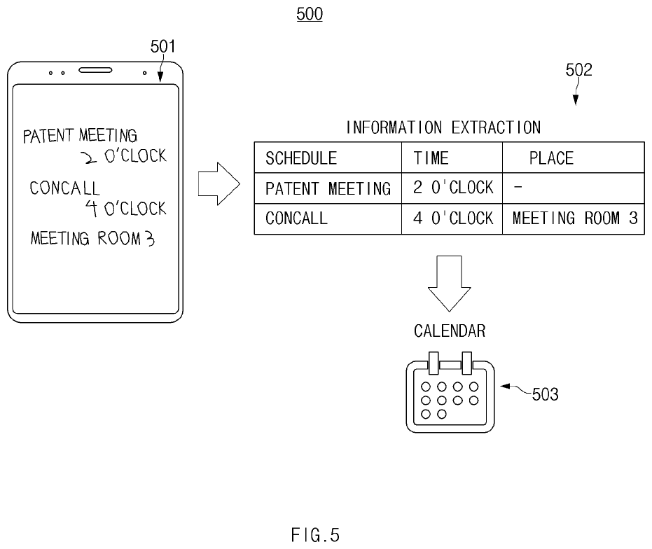

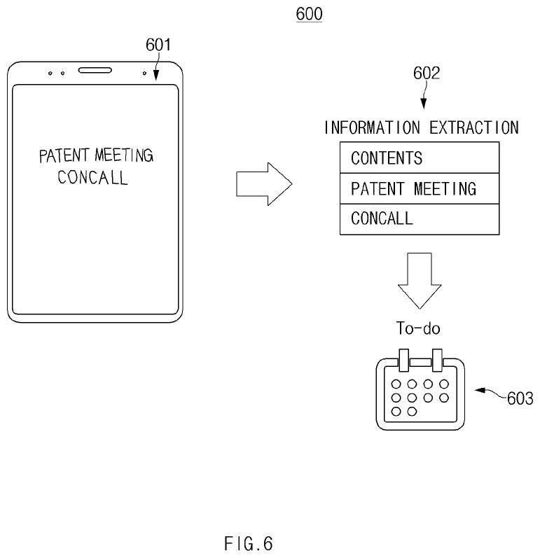

Hereinafter, a method for analyzing a pattern of an electronic note 501 in an electronic device will be described with reference to FIGS. 5 and 6. FIG. 5 is a diagram 500 schematically illustrating a method for analyzing a pattern of an electronic note in an electronic device according to an embodiment. FIG. 6 is a diagram 600 schematically illustrating a method for analyzing a pattern of an electronic note in an electronic device according to an embodiment.

Referring to FIG. 5, the electronic device can analyze an electronic note 501 to identify various note contents such as, for example “patent meeting”, “2 o′clock”, “concall”, “4 o′clock”, and “meeting room 3” are included in the electronic note 501 and can identify that schedule information corresponds to “patent meeting” and “concall”, time information corresponds to “2 o′clock” and “4 o′clock”, and place information corresponds to “meeting room 3”. The electronic device can analyze and compare the electronic note 501 with the data form corresponding to an application, and determine that the note contents is similar to the data form of a calendar application, such as date, time, schedule, and the like as a result of analyzing the electronic note 501.

The electronic device can extract information 502 from the electronic note 501. Based on the electronic note 501, the electronic device can determine that “patent meeting” and “2 o′clock” are input on the same line to determine that “patent meeting” is scheduled at “2 o′clock”. Also, based on the electronic note 501, the electronic device can determine that “concall” and “4 o′clock” are input on the same line to determine that the “concall” is scheduled at “4 o′clock”. In addition, the electronic device can determine that “concall” is scheduled in “meeting room 3” by determining that “meeting room 3” is input closer (e.g., closer in terms of distance displayed on the screen) to “concall” than to “patent meeting”.

According to an embodiment, the electronic device can store the information 502 extracted from the electronic note 501 in a corresponding application, e.g., a calendar application 503. Although not shown in FIG. 5, the electronic device can receive feedback from the user as to determine whether the extracted information 502 matches the intent before storing the information 502 extracted from the electronic note 501 in the calendar application 503 and store the information 502. According to the above-described process, the user can store the schedule in the calendar application 503 through input through the note application without separately storing the schedules of “patent meeting” and “concall” in the calendar application 503. In addition, the user can view, modify, and manage the schedules which had been input to the note application through the calendar application 503.

Referring to FIG. 6, the electronic device can analyze an electronic note 601 to identify that “patent meeting” and “concall” are included in the electronic note 601, and identify that only schedule information about a thing to-do or “to-do event” is included without time information. The electronic device can analyze the electronic note 601 and compare the electronic note 601 with the data forms of applications, and can determine that note contents is similar to the data form corresponding to a to-do list application including only schedule information about things to-do or “to-do event” which omit time information, as a result of analyzing the electronic note 601

The electronic device can store information 602 extracted from the electronic note 601 in a to-do list application 603. Although not shown in FIG. 6, the electronic device can receive feedback from the user as to determine whether the extracted information 602 matches the intent before storing the information 602 extracted from the electronic note 601 in the to-do list application 603 and store the information 602.

According to the above-described process, the user can store the schedule in the to-do list application 603 through input of the note application without separately storing the schedules of “patent meeting” and “concall” in the to-do list application 603. In addition, the user can view, modify, and manage the schedules which had been input to the note application through the to-do list application 603. The electronic device can determine an application determined to be suitable by figuring out the user's intent according to the contents input into the electronic note by the user and store the contents of the electronic note.

Referring again to FIG. 4, when it is determined at operation 404 that a pattern does not exist in the electronic note, the electronic device can determine the intent of the note at operation 405. Although it is illustrated in FIG. 4 that the intent of the note is determined at operation 405 when it is determined at operation 404 that the pattern does not exist in the electronic note, the intent of the note can be determined at operation 405 when it is determined in operation 404 that the pattern exists in the electronic note.

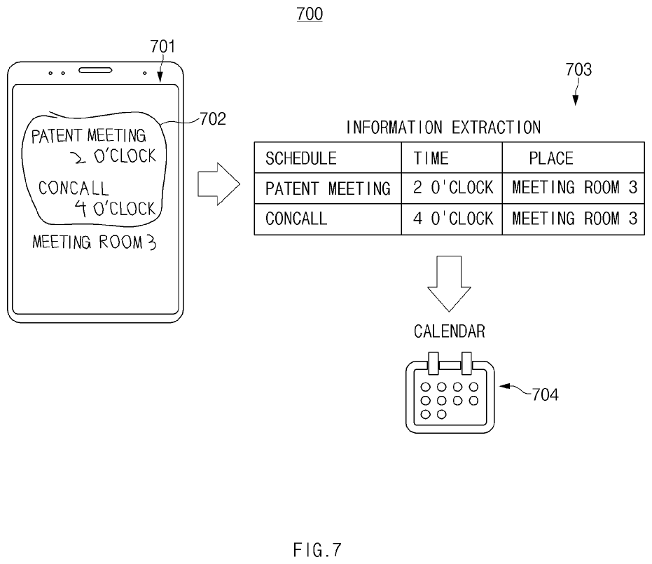

Hereinafter, a method for analyzing a pattern of an electronic note 701 in an electronic device will be described with reference to FIG. 7. FIG. 7 is a diagram 700 schematically illustrating a method for analyzing an intent of an electronic note in an electronic device according to an embodiment.

Referring to FIG. 7, an electronic device can identify that there is more picture information 702 that is not analyzed by pattern analysis in the electronic note 701 in addition to a result of pattern analysis of the electronic note 701. The electronic device can determine that “patent meeting 2 o′clock” and “concall 4 o′clock” are scheduled in the place of “meeting room 3” by determining visual information 702 in which “patent meeting 2 o′clock” and “concall 4 o′clock” are bundled by one figure in the electronic note 701. The electronic device can estimate the intent of a user to write the note by comprehensively analyzing the visual part of the electronic note 701, by not only analyzing the characters included in the electronic note 701, but also by analyzing figures and the arrangement between the characters and the figures.

The electronic device can store information 703 extracted from the electronic note 701 in a corresponding application, e.g., a calendar application 704. Although not shown in FIG. 7, the electronic device can receive feedback from the user as to determine whether the extracted information 703 matches the intent before storing the information 703 extracted from the electronic note 701 in the calendar application 704 and store the information 703. Through the above-described process, the user can store the schedule in the calendar application 704 through input of the note application without separately storing the schedules of “patent meeting” and “concall” in the calendar application 704. In addition, the user can view, modify, and manage the schedules which had been input to the note application through the calendar application 704.

Referring back to FIG. 4, when it is determined at operation 406 that the keyword, pattern, and/or intent identified in the electronic note exist (e.g., is stored in database 243), the electronic device can receive confirmation of a result of identification from the user. According to an embodiment, when the electronic device receives the user's approval input for the identified keyword, pattern, and/or intent at operation 407, the electronic device can proceed to operation 304 of FIG. 3, and when the user's approval input is not received, at operation 408, the electronic device can receive the user's modification for the identified keyword, pattern, and/or intent. When the user's modification for the identified keyword, pattern, and/or intent is received at operation 408, the electronic device can proceed to operation 304 of FIG. 3.

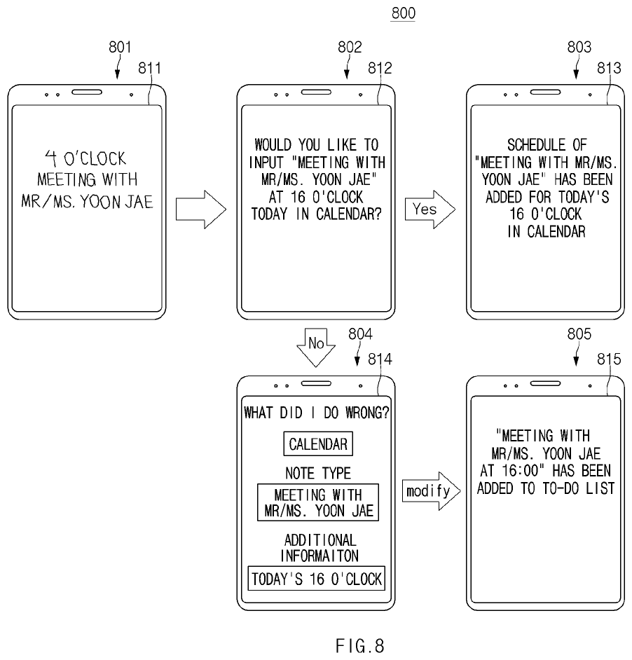

Hereinafter, a method for correcting contents identified from an electronic note in an electronic device will be described with reference to FIG. 8. FIG. 8 is a diagram 800 schematically illustrating a method for correcting contents identified from an electronic note in an electronic device according to an embodiment.

Referring to FIG. 8, at operation 801, an electronic device can receive an electronic note 811 from a user, or load the electronic note 811 stored in the electronic device. According to an embodiment, the electronic device can identify “4 o′clock” and “meeting with Mr./Ms. Yoon Jae” from the electronic note 811. As the electronic device identifies time information and schedule information from the electronic note 811, the electronic device can identify that the data forms thereof are similar to those of a calendar application.

At operation 802, the electronic device can display a user interface screen 812 for confirming contents identified and a user intent estimated from the electronic note 811. According to an embodiment, the electronic device can display the user interface screen 812 indicating a message “Would you like to input “meeting with Mr./Ms. Yoon Jae” at 16 o′clock today in a calendar?” to allow the user to confirm whether the contents identified from the electronic note 811, “4 o′clock”, “meeting with Mr./Ms. Yoon Jae” and the calendar application are intended.

When there is the user's approval input at operation 802, the electronic device can store “4 o′clock” and “meeting with Mr./Ms. Yoon Jae”, which are the contents identified from the electronic note 811 at operation 803, in a calendar application, and display a screen 813 notifying completion of storage. According to an embodiment, the screen 813 notifying the completion of storage can display ‘Schedule of “Meeting with Mr./Ms. Yoon Jae” has been added for today's 16 o′clock in the calendar.

When there is no user's approval input at operation 802, the electronic device can display a user interface screen 814 for correcting the contents identified from the electronic note 811 at operation 804. According to an embodiment, the electronic device can add “note type: calendar”, “note contents: meeting with Mr./Ms. Yoon Jae”, “additional information: today's 16 o′clock” and a phrase to guide user feedback, “What did I do wrong?” to the user interface screen 814 for correcting the contents identified from the electronic note 811.

When the user's corrected contents is input at operation 804, at operation 805, the electronic device can store the note contents according to the corrected contents. According to an embodiment, when the electronic device receives a correction input, such as “memo type: to-do list”, with respect to “memo type: calendar” at operation 804, the electronic device can proceed to operation in operation 805 and can store “4 o′clock” and “meeting with Mr./Ms. Yoon Jae”, which are contents identified from the electronic note 811, in the to-do list application, and display a screen 815 notifying the completion of storage. According to an embodiment, the screen 815 for notifying the completion of storage can display “Meeting with Mr./Ms. Yoon Jae at 16:00” has been added to the to-do list application’.

The operation sequence of the electronic device described above with reference to FIG. 4 is only an example, and one or more operations of the flowchart of FIG. 4 can be omitted, added, or the sequence can be changed. Also, some of the flowchart of FIG. 4 can be merged and performed as one process, or can be separated and performed as a plurality of processes.

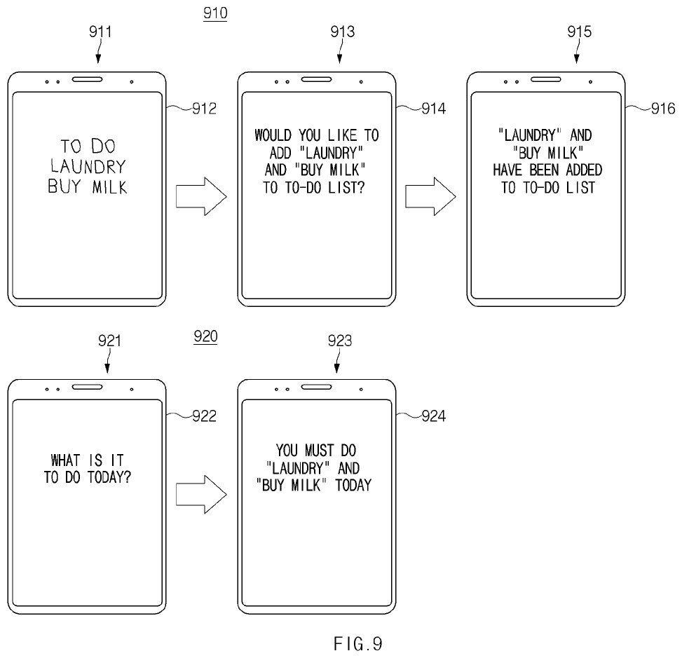

Hereinafter, operation of an electronic device according to an embodiment will be described with reference to FIG. 9. FIG. 9 is a diagram schematically illustrating a method 910 for analyzing and storing an electronic note in an electronic device and a method 920 for searching for stored contents at a user's request, according to an embodiment.

The method 910 for analyzing and storing an electronic note in an electronic device will be described with reference to FIG. 9. According to an embodiment, the electronic device (e.g., the electronic device 101 of FIG. 1) can analyze contents of an electronic note 912 at operation 911. According to an embodiment, the electronic device can identify “to-do”, “laundry”, and “buy milk” included in the electronic note 912, and estimate that the electronic note 912 is intended to input a “to-do list” because a keyword “to-do” is identified.

at operation 913, the electronic device can display a user interface screen 914 for obtaining a user's approval for “to-do”, “laundry”, and “buy milk” identified in the electronic note 912. According to an embodiment, the user interface screen 914 for obtaining the user's approval can include a phrase ‘Would you like to add “laundry”, and “buy milk” to the to-do list?’.

When there is the user's approval at operation 913, the electronic device can store “laundry” and “buy milk” in a to-do list application at operation 915. At operation 915, the electronic device can further display a screen 916 displaying a result of storage. According to an embodiment, the screen 916 displaying the result of storage result can include phrases ‘“laundry” and “buy milk” have been added to the to-do list’.

The method 920 for searching stored contents at a user's request in an electronic device will be described with reference to FIG. 9. According to an embodiment, the electronic device can receive a user's utterance through a voice recognition agent (e.g., the voice recognition agent 260 of FIG. 2) at operation 921. According to an embodiment, at operation 921, the electronic device can receive an utterance “what is it to do today?” or “what is there to do today,” from the user through the voice recognition agent, and display a screen 922 including the user's utterance.

The electronic device can determine whether the received utterance intends to search a note file. According to an embodiment, the electronic device can identify a keyword (e.g., “to-do”) of the received utterance to estimate that the user has requested to search for a “to-do list”.

At operation 923, according to an embodiment, the electronic device can search database (e.g., the database 243 of FIG. 2) for the “to-do list” as it is predicted that the received user's utterance has requested to search the database (e.g., the database 243 of FIG. 2) for the “to-do list”. At operation 923, according to an embodiment, as the electronic device searches for the “to-do list” in the database, the electronic device can search for “laundry” and “buy milk” which are the “to-do list” stored at operation 915. At operation 923, according to an embodiment, the electronic device can display a search result screen 924, and the search result screen 924 can include a phrase ‘“You must do “laundry” and “buy milk” today’.

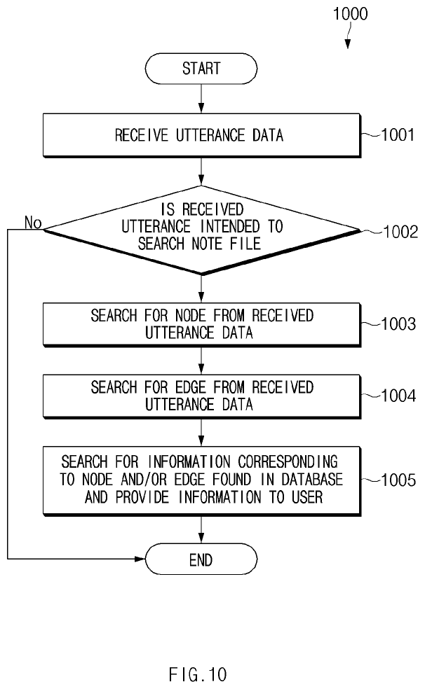

Hereinafter, an operation of an electronic device according to an embodiment will be described with reference to FIG. 10. FIG. 10 is a flowchart 1000 illustrating an operation of an electronic device according to an embodiment. According to an embodiment, at operation 1001, an electronic device (e.g., the electronic device 101 of FIG. 1) can receive a user's utterance through a voice recognition agent (e.g., the voice recognition agent 260 of FIG. 2).

At operation 1002, the electronic device can determine whether the received utterance intends to search a note file. According to an embodiment, the electronic device can identify keywords (e.g., “to do”, “schedule”, “today”, or the like) in the received utterance to determine whether the received utterance intends to search the note file. For example, when the electronic device receives the utterance ‘what is it to do today?’ from the user through the voice recognition agent, the electronic device can identify a keyword (e.g., “to do”) of the received user's utterance to estimate that the user has requested to search for a “to-do list”.

At operation 1002, when it is determined that the received utterance intends to search the note file, at operation 1003 the electronic device can search for a node in the received utterance data. The node can refer to an element, or phrase to be found in the received utterance data. For example, the electronic device can analyze a node, which is an element, or phrase to be found in the received utterance “what is it to do today?” as “to do”.

At operation 1004, the electronic device can search for an edge in the received utterance data. The edge can refer to detail information such as a specific term, for example, to be found in the phrase of the received utterance data. For example, the electronic device can analyze an edge, which is detail information or specific term such as “today, for example, to be found in the received utterance “what is it to do today?”.

At operation 1005, the electronic device can search for information corresponding to the node and/or edge found in the database (e.g., the database 243 of FIG. 2) and provide the information to the user. For example, information extracted from the electronic note through the processes of FIGS. 3 and/or 4 can be stored in the database, and the user can search for information stored in the database according to the process of FIG. 10. According to an embodiment, the information extracted from the electronic note stored in the database can be in the form of a knowledge based graph. The knowledge based graph is a data type in which pieces of related information are connected to each other, and can be in a form in which an edge indicating a relation between one or more nodes in connected with other related nodes. The electronic device can search for corresponding information in the knowledge based graph of the database based on the node and/or edge identified from the user's utterance and provide the information to the user. According to an embodiment, the electronic device can search for “laundry” and “buy milk” corresponding to “today” and “to do” in the database and provide them to the user.

According to an embodiment, the electronic device can receive the utterance “what is it to do today?”, analyze a node as “today” at operation 1003, analyze an edge as “to-do” in operation 1004, and search for “Patent strategy meeting” and “visit hospital” corresponding to “today” and “to-do” and provide them to a user at operation 1005.

According to an embodiment, the electronic device can receive the utterance “Where is the meeting place?” and analyze a node as “meeting” at operation 1003, analyze an edge as “place” at operation 1004, and search for “large meeting room” corresponding to “meeting” and “place” and provide it to a user at operation 1005.

According to an embodiment, the electronic device can receive the utterance “what time is the meeting?”, analyze a node as “meeting” at operation 1003, analyze an edge as “what time” at operation 1004, and search for “17:00” corresponding to “meeting” and “what time” and provide it to a user at operation 1005.

According to the present disclosure, a user is able to store, manage, and search for various personal information and memos using simple methods such as text, handwriting, and voice, and various notes inputted into the electronic device can be automatically classified according to the input contents and the estimated input intent and stored in the electronic device in a structured form. After that, the user can easily search for and modify information previously stored in the electronic device through a voice recognition agent, or the like.

According to an embodiment of the disclosure, an electronic device can include a memory which stores a plurality of applications including an electronic note application and at least one electronic note file, and a processor connected to the memory, and the memory can store instructions which, when executed, cause the processor to identify contents included in the electronic note file, compare the identified contents with data forms of the plurality of applications, estimate a category of the electronic note file based on a result of comparing the identified contents with the data forms of the plurality of applications, and store the identified contents in an application corresponding to the category among the plurality of applications.

According to an embodiment of the disclosure, the instructions can cause the processor to determine whether a keyword indicating a user's intent is included in the identified contents.

According to an embodiment of the disclosure, the instructions can cause the processor to estimate a user's intent based on a visual element of the electronic note file.

According to an embodiment of the disclosure, the visual element can include at least one of a figure included in the electronic note file, a location of the figure included in the electronic note file, a distance between characters included in the electronic note file, an order of the characters included in the electronic note file, and a location of a character included in the electronic note file, and an arrangement between the characters included in the electronic note file.

According to an embodiment of the disclosure, the instructions can cause the processor to receive a user's approval input for the content identified from the electronic note file.

According to an embodiment of the disclosure, the instructions can cause the processor to receive a user's correction input for the contents when there is no user's approval input for the contents identified from the electronic note file.

According to an embodiment of the disclosure, the instructions can cause the processor to receive a user input through the electronic note application to generate the electronic note file, and correct the input data or content included in the electronic note file.

According to an embodiment of the disclosure, the instructions can cause the processor to store the contents identified from the electronic note file in a form of a knowledge based graph.

According to an embodiment of the disclosure, the instructions can cause the processor to receive an utterance from a user through a voice recognition agent, and search for information corresponding to the received utterance from the knowledge based graph when it is estimated that the received utterance is intended to search the electronic note file.

According to an embodiment of the disclosure, the instructions can cause the processor to identify a node and an edge from the received utterance, and search for information corresponding to the received utterance from the knowledge based graph based on the identified node and edge.

According to an embodiment of the disclosure, a method for managing an electronic note, comprising: identifying contents included in an electronic note file stored in a memory of an electronic device, comparing the identified contents with data forms of a plurality of applications stored in the memory, estimating a category of the electronic note file based on a result of comparing the identified contents with the data forms of the plurality of applications, and storing the identified contents in an application corresponding to the category among the plurality of applications.

According to an embodiment of the disclosure, the method can further include determining whether a keyword indicating a user's intent is included in the identified contents.

According to an embodiment of the disclosure, the method can further include estimating a user's intent based on visual elements of the electronic note file.

According to an embodiment of the disclosure, wherein the visual element can include at least one of a figure included in the electronic note file, a distance between characters included in the electronic note file, an order of the characters included in the electronic note file, and an arrangement between the characters included in the electronic note file.

According to an embodiment of the disclosure, the method can further include receiving a user's approval input for the contents identified from the electronic note file.

According to an embodiment of the disclosure, the method can further include receiving a user's correction input for the contents when there is no user's approval input for the contents identified from the electronic note file.

According to an embodiment of the disclosure, the method can further include receiving a user input through the electronic note application to generate the electronic note file, and correcting input data or content included in the electronic note file.

According to an embodiment of the disclosure, the method can further include storing the contents identified from the electronic note file in a form of a knowledge based graph.

According to an embodiment of the disclosure, the method can further include receiving an utterance from a user through a voice recognition agent; and searching for information corresponding to the received utterance from the knowledge based graph when it is estimated that the received utterance is intended to search the electronic note file.

According to an embodiment of the disclosure, the method can further include identifying a node and an edge from the received utterance, and search for information corresponding to the received utterance from the knowledge based graph based on the identified node and edge.

1. An electronic device comprising:
a memory which stores a plurality of applications including an electronic note application and an electronic note file; and
a processor connected to the memory,
wherein the memory stores instructions which, when executed, cause the processor to:
identify contents included in the electronic note file,
compare the identified contents with data forms corresponding to the plurality of applications,
estimate a category of the electronic note file based on a result of the comparison, and
store the identified contents in an application corresponding to the category among the plurality of applications.

2. The electronic device of claim 1, wherein the instructions cause the processor to determine whether a keyword indicating a user's intent is included in the identified contents.

3. The electronic device of claim 1, wherein the instructions cause the processor to estimate a user's intent based on a visual element of the electronic note file.

4. The electronic device of claim 3, wherein the visual element includes one or a combination of a figure included in the electronic note file, a location of the figure included in the electronic note file, a distance between characters included in the electronic note file, an order of the characters included in the electronic note file, and a location of a character included in the electronic note file, and an arrangement between the characters included in the electronic note file.

5. The electronic device of claim 1, wherein the instructions cause the processor to receive a user's approval input corresponding to the contents identified from the electronic note file.

6. The electronic device of claim 5, wherein the instructions cause the processor to receive a user's correction input for the contents when the user's approval input is not received.

7. The electronic device of claim 1, wherein the instructions cause the processor to:
receive a user input through the electronic note application to generate the electronic note file, and
correct a the contents included in the electronic note file.

8. The electronic device of claim 1, wherein the instructions cause the processor to store the contents identified from the electronic note file in a form of a knowledge based graph.

9. The electronic device of claim 8, wherein the instructions cause the processor to:
receive an utterance from a user through a voice recognition agent, and
search for information corresponding to the received utterance from the knowledge based graph when it is estimated that the received utterance is intended to search the electronic note file.

10. The electronic device of claim 9, wherein the instructions cause the processor to identify one or both of a node and an edge from the received utterance, and search for information corresponding to the received utterance from the knowledge based graph based on one or both of the identified node and the identified edge.

11. A method for managing an electronic note, the method comprising:
identifying contents included in an electronic note file stored in a memory of an electronic device;
comparing the identified contents with data forms corresponding to a plurality of applications stored in the memory;
estimating a category of the electronic note file based on a result of comparison; and
storing the identified contents in an application corresponding to the category among the plurality of applications.

12. The method of claim 11, further comprising:
determining whether a keyword indicating a user's intent is included in the identified contents.

13. The method of claim 11, further comprising:
estimating a user's intent based on visual elements of the electronic note file.

14. The method of claim 13, wherein the visual elements includes one or more of a figure included in the electronic note file, a distance between characters included in the electronic note file, an order of the characters included in the electronic note file, and an arrangement between the characters included in the electronic note file.

15. The method of claim 11, further comprising:
receiving a user's approval input for the identified contents.

16. The method of claim 15, further comprising:
receiving a user's correction input for the identified contents when the user's approval input is not received.

17. The method of claim 11, further comprising:
receiving a user input through an electronic note application to generate the electronic note file; and
correcting the identified contents included in the electronic note file.

18. The method of claim 11, further comprising:
storing the identified contents in a form of a knowledge based graph.

19. The method of claim 18, further comprising:
receiving an utterance from a user through a voice recognition agent; and
searching for information corresponding to the received utterance from the knowledge based graph when it is estimated that the received utterance is intended to search the electronic note file.

20. The method of claim 19, further comprising:
identifying one or both of a node and an edge from the received utterance, and searching for information corresponding to the received utterance from the knowledge based graph based on one or both of the identified node and the identified edge.
